(19) United States
(12) Patent Application Publication
(10) Pub. No.: US 2011/0060592 A1
(43) Pub. Date: Mar. 10, 2011

(54) IPTV SYSTEM AND SERVICE METHOD USING VOICE INTERFACE

(76) Inventors: Byung Ok Kang, Chungcheongnam-do (KR); Eui Sok Chung, Daejeon (KR); Ji Hyun Wang, Daejeon (KR); Mi Ran Choi, Daejeon (KR)

(21) Appl. No.: 12/784,439

(22) Filed: May 20, 2010

(30) Foreign Application Priority Data
Sep. 10, 2009 (KR) 10-2009-0085423

(51) Int. Cl. G10L 21/00; H04N 7/173

(52) U.S. Cl. 704/275; 725/109; 704/E11.001

(57) ABSTRACT

Provided is an IPTV system using voice interface which includes a voice input device, a voice processing device, a query processing and content search device, and a content providing device. The voice processing device performs voice recognition to convert voice into a text. The voice processing device includes a voice preprocessing unit, a sound model database, a language model database, and a decoder. The voice preprocessing unit performs preprocessing which includes improving the quality of sound or removing noise for the received voice, and extracts a feature vector. The decoder converts the feature vector into a text by using a sound model and a language model. Moreover, the voice processing device stores the profile and preference of a user to provide personalized service. The result of voice recognition is updated in a sound model database and a user profile database each time service for a user is provided, the performance of voice recognition and the performance of personalized service can continuously be improved.

### CROSS-REFERENCE TO RELATED APPLICATIONS

This application claims priority under 35 U.S.C. §119 to Korean Patent Application No. 10-2009-0085423, filed on Sep. 10, 2009, in the Korean Intellectual Property Office, the disclosure of which is incorporated herein by reference in its entirety.

### TECHNICAL FIELD

The following disclosure relates to an Internet Protocol Television (IPTV) system and service method, and in particular, to an IPTV system and service method using a voice interface.

### BACKGROUND

The technical field of the present invention relates to the art about a system and Video On Demand (VOD) service for IPTV.

IPTV refers to service that provides information service, movies and broadcasting to TV over the Internet. A TV and a set-top box connected to the Internet are required for being served IPTV. In that TV and the Internet are combined, IPTV may be called the one type of digital convergence. Difference between the existing Internet TV and IPTV is in that IPTV uses TV instead of a computer monitor and uses a remote controller instead of a mouse. Accordingly, even unskilled computer users may simply search contents in the Internet with a remote controller and receive various contents and additional service, which are provided over the Internet, such as movie appreciation, home shopping and on-line games. IPTV has no difference with respect to general cable broadcasting or satellite broadcasting in view of providing video and broadcasting content, but IPTV provides interactivity. Unlike broadcasting or cable broadcasting and satellite broadcasting, IPTV allows viewers to watch only desired programs at convenient time. Such interactivity may derive various types of services.

In current IPTV service, users click the button of a remote controller to receive VOD service or other services. Comparing with computers having user interface using a keyboard and a mouse, IPTV does not use separate user interface other than a remote controller up to now. This is because service using IPTV is still limited and only remote controller-dependent service is provided. When various services are provided in the future, a remote controller will be insufficient.

### SUMMARY

In one general aspect, an IPTV system using voice interface includes: a voice input device receiving a user's voice; a voice processing device receiving the voice which is inputted to the voice input device, and performing voice recognition to convert the voice into a text; a query processing and content search device receiving the converted text to extract a query language, and searching content by using the query language as a keyword; and a content providing device providing the searched content to the user.

The voice processing device may include: a voice preprocessing unit which includes improving the quality of sound or removing noise for the received voice, and extracting a feature vector; a sound model database storing a sound model which is used to convert the extracted feature vector into a text; a language model database storing a language model which is used to convert the extracted feature vector into a text; and a decoder converting the feature vector into a text by using the sound model and the language model.

The sound model database may include: at least one individual adaptive sound model database storing a sound model which is adapted to a specific user; and a speaker sound model database used to recognize voice of a user instead of the specific user. The voice processing device may further include: a user register including a first speaker adaptation unit which creates the individual adaptive sound model database corresponding to the user by user; and a speaker determination unit receiving voice which is inputted to the voice input device, and determining a user which corresponds to the individual adaptive sound model database.

The IPTV system may further include a second speaker adaptation unit improving the individual adaptive sound model database of the user by using the input voice of the user. The user register may further include a user profile writing unit writing a user profile which includes at least one of an ID, sex, age and preference of the user by user. The voice processing device may further include: a user profile database storing the user profile; and a user preference adaptation unit storing at least one of the extracted query language, a list of the searched content and the content provided to a user in the user profile database to improve the user profile.

The voice processing device may further include: an adult/child determination unit receiving voice which is inputted to the voice input device, and determining whether a user is an adult or a child using voice characteristic which includes a pitch or a vocalization pattern; and a content restriction unit restricting the content which is provided when the user is determined as a child.

In the IPTV system, the voice input device may be disposed in a user terminal, the voice processing device may be disposed in a set-top box, and voice which is inputted to the voice input device may be transmitted to the voice processing device in any one of Bluetooth, ZigBee, Radio Frequency (RF), WiFi and WiFi+wired network.

On the other hand, the voice input device and the voice processing device may be disposed in a user terminal or a set-top box, and in the case of the latter, the voice input device may be configured with a multi-channel microphone.

The voice input device and the voice preprocessing unit of the voice processing device may be disposed in a user terminal, a part other than the voice preprocessing unit of the voice processing device may be disposed in a set-top box, and a feature vector which is extracted from the voice preprocessing unit may be transferred to a part other than the voice preprocessing unit of the voice processing device via a wireless communication.

In another general aspect, an IPTV service method using voice interface includes: inputting a query voice production of a user; voice processing the voice production to convert the voice production into a text; extracting a query language from the converted text to create a content list corresponding to the query language; providing the content list to the user; and providing content which is included in the content list to the user according to selection of the user.

The IPTV service method may further include creating an individual adaptive sound model database corresponding to the user by user. In this case, the voice processing of the voice production may include receiving input voice to determine a user corresponding to the individual adaptive sound model database. When the individual adaptive sound model database corresponding to the user exists, the voice production may be converted into a text by voice processing the voice production with the individual adaptive sound model database corresponding to the determined user. In the determining of a user, when the individual adaptive sound model database corresponding to the user does not exist, the voice production may be converted into a text by voice processing the voice production with a speaker sound model database. In the determining of a user, when the individual adaptive sound model database corresponding to the user exists but determination reliability for the determined user is lower than a predetermined reference value, the voice production may be converted into a text by voice processing the voice production with the speaker sound model database.

The IPTV service method may further include improving the individual adaptive sound model database corresponding to the user by using the voice production of the user which is inputted. Moreover, the IPTV service method may further include: receiving a user profile, which includes at least one of an ID, sex, age and preference of a user, from the user; storing the user profile in a user profile database; and storing at least one of the extracted query language, the searched content list and the content provided to the user in the user profile database to improve the user profile.

The IPTV service method may further include: receiving voice which is inputted to the voice input device, and determining whether a user is an adult or a child using voice characteristic which includes a pitch or vocalization pattern of the voice production which is inputted; and restricting the content which is provided when the user is determined as a child.

Other features and aspects will be apparent from the following detailed description, the drawings, and the claims.

### BRIEF DESCRIPTION OF THE DRAWINGS

FIG. 1 is a block diagram illustrating the basic configuration of an IPTV system using voice interface according to an exemplary embodiment.

FIG. 2 is a block diagram illustrating the configuration of an IPTV system using voice interface according to another exemplary embodiment.

FIG. 3 is a block diagram illustrating the configuration of an IPTV system according to another exemplary embodiment.

FIG. 4 is a block diagram illustrating the configuration of an IPTV system according to another exemplary embodiment.

FIG. 5 is a block diagram illustrating the configuration of an IPTV system using voice interface according to another exemplary embodiment.

FIG. 6 is a block diagram illustrating a voice processing device which is applied to an IPTV system using voice interface to which personalization service is added, according to another exemplary embodiment.

FIG. 7 is a block diagram illustrating a voice processing device which is applied to an IPTV system using voice interface to which personalization service is added, according to another exemplary embodiment.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to he limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments will be described in detail with reference to the accompanying drawings.

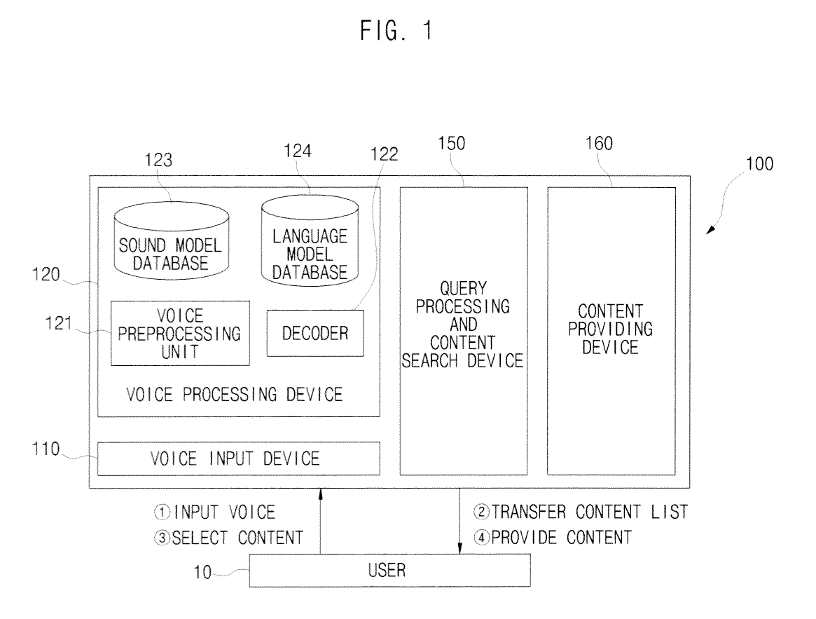

FIG. 1 is a block diagram illustrating the basic configuration of an IPTV system using voice interface according to an exemplary embodiment.

Referring to FIG. 1, an IPTV system 100 using voice interface according to an exemplary embodiment is largely configured with a voice input device 110, a voice processing device 120, a query processing and content search device 150 and a content providing device 160.

The voice processing device 120 performs voice recognition on voice production that is inputted from a user 10 to perform a function of converting into a text. The voice processing device 120 includes a sound model database 123. a language model database 124, a voice preprocessing unit 121, and a decoder 122.

The voice preprocessing unit 121 performs preprocessing such as improving the quality of voice or removing noise on an input voice signal, extracts the feature of a voice signal, and outputs a feature vector. The decoder 122 receives a feature vector from the voice preprocessing unit 121 as an input, performs actual voice recognition for converting into a text on the basis of the sound model database and the language model database 124. The sound model database 123 and the language model database 124 store a sound model and a language model that are used to convert the feature vector outputted from the voice preprocessing unit 121 into a text, respectively.

The query processing and content search device 150 receives the converted text as an input, extracts a query language from a user's voice which is received from the voice processing device 120, searches content according to metadata and an internal search algorithm by using the extracted query language as a keyword, and transfers the search result to the user 10 through a display (not shown). Herein, the metadata is data that may be used in search because it has additional information such as genres, actor names, director names, atmosphere, OST and related search languages as a table. A query language may be an isolating language such as content name/actor name/genre name/director name, and may be a natural language such as “desire a movie in which Dong Gun JANG appears.

The content providing device 160 provides content, which the user 10 searches and selects through the IPTV system 100 using a voice interface, to the user 10 as the original function of IPTV.

Each of elements, which configure the IPTV system 100 using voice interface according to an exemplary embodiment, may be disposed in a user terminal, a set-top box or an IPTV service providing server according to system shapes and necessities. For example, the voice input device 110 may be disposed in the user terminal or the set-top box. The voice preprocessing unit 121 of the voice processing device 120 or the entirety of the voice processing device 120 may be disposed in the user terminal or the set-top box. The query processing and content search device 150 may be disposed in the set-top box or the IPTV service providing server according to necessities. Exemplary embodiments of the IPTV system 100 using a voice interface that has various configuration in this way will be described below.

In the IPTV system 100 using voice interface according to an exemplary embodiment, the flow of a content providing method is simply illustrated in FIG. 1.

As illustrated in FIG. 1, the user 10 inputs voice to the IPTV system 100 using a voice interface by voice in operation \textcircled{1}. In operation \textcircled{2}, the IPTV system 100 processes voice inputted from the user 10 through the voice processing device 120, and creates the list of desired contents through the query processing and content search device 150 to transfer the created list to the user 10. In operation \textcircled{3}, the user 10 selects desired content from the content list that is provided through operation \textcircled{2}, and transfers the selected content to the IPTV system 100 using a voice interface. In operation \textcircled{4}, the content providing device 160 transfers the content, which is selected by the user 10 through operation \textcircled{3}, to the user 10 through a display (not shown) such as TV. Through such a series of operations, the IPTV system 100 may transfer content, which is required by the user 10, to a user through a voice interface.

Hereinafter, embodiments according to system shapes will be described. However, repetitive description on configuration and function which are the same as those of an exemplary embodiment illustrated in FIG. 1 will be omitted or a schematic description will be made on those.

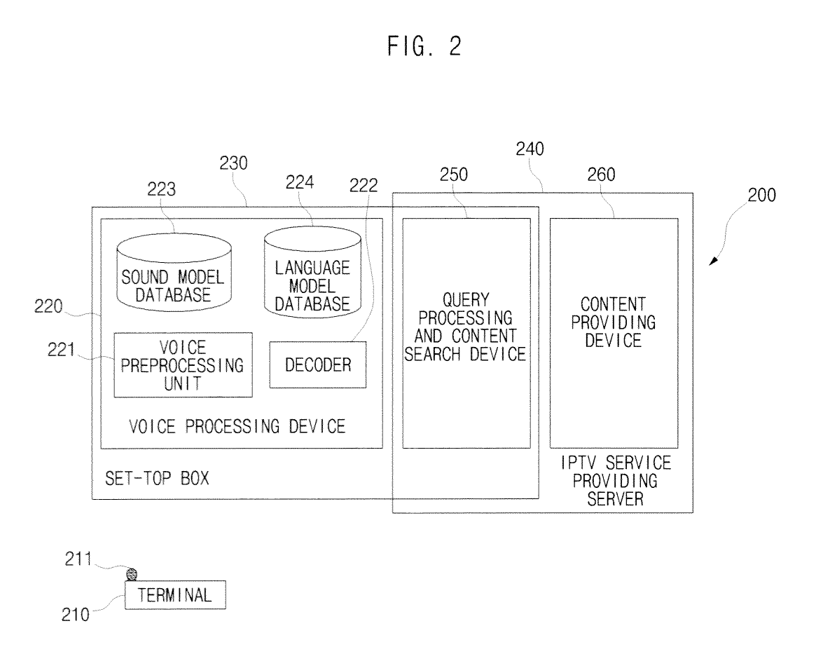

FIG. 2 is a block diagram illustrating the configuration of an IPTV system 200 using voice interface according to another exemplary embodiment. In an IPTV system 200 according to another exemplary embodiment, a voice processing device 220 is disposed in a set-top box 230, and has a shape in which a microphone 211 for inputting voice is mounted on a user terminal 210 such as a remote controller.

That is, the microphone 211 that is mounted on the user terminal 210 serves as a voice input device, and transfers the input voice of a user to the voice processing device 220 of the set-top box 230 through a wireless transmission scheme such as Bluetooth, ZigBee, Radio Frequency (RF) and WiFi or “WiFi+wired network”. Herein, the “WiFi+wired network” refers to a network in which the set-top box 230 is connected to a wired network, WiFi is supported in the user terminal 210 and a WiFi access point is connected to a wired network in home.

The configuration and function of the voice processing device 220 is similar to those of an exemplary embodiment that has been described above with reference to FIG. 1. The voice processing device 220 includes a sound model database 223, a language model database 224, a voice preprocessing unit 221, and a decoder 222.

A query processing and content search device 250 may be disposed in the set-top box 230 or an IPTV service providing server 240 according to system shapes. A content providing device 260 is disposed in the IPTV service providing server 240 of an IPTV service provider.

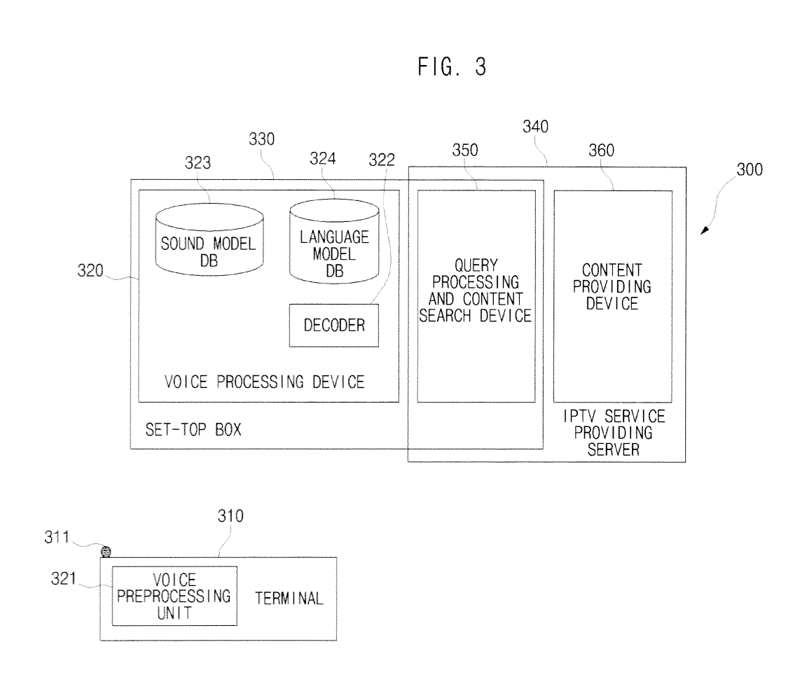

FIG. 3 is a block diagram illustrating the configuration of an IPTV system 300 using voice interface according to another exemplary embodiment. In an IPTV system 300 according to another exemplary embodiment, a voice processing device 320 is disposed in a set-top box 330, a microphone 311 for inputting voice is mounted on a terminal 310 such as a remote controller, and the terminal 310 performs the preprocessing function of a voice processing device. For this, a voice preprocessing unit 321 is included in the terminal 310, and the voice processing device 320 of the set-top box 330 includes a sound model database 223, a language model database 224 and a decoder 222, other than the voice preprocessing unit 321.

In processing voice, distributed speech recognition, corresponding to a shape in which the voice preprocessing unit 321 of the terminal 310 and the voice processing device 320 of the set-top box are distributed, is performed. In this case, a feature vector is generated through a feature extraction operation after improving the quality of voice and removing noise are performed for voice, which is inputted to the terminal 310 through a microphone 311 from a user, by the voice preprocessing unit 321 of the terminal 310, and the terminal 310 transmits a feature vector, which is processed through a voice preprocessing unit 321, instead of a voice signal to the voice processing device 320 of the set-top box 330. This decreases limitations due to transmission ability or a transmission error between the terminal 310 and the set-top box 330 according to a wireless transmission scheme.

The position, configuration and function of a query processing and content search device 350 and the position, configuration and function of a content providing device 360 are similar to those of another exemplary embodiment that has been described above with reference to FIG. 2.

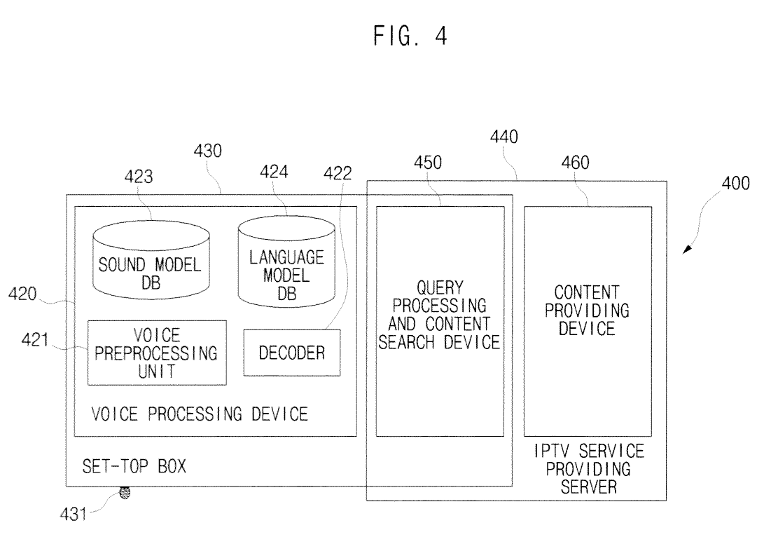

FIG. 4 is a block diagram illustrating the configuration of an IPTV system 400 using voice interface according to another exemplary embodiment. In an IPTV system 400 according to another exemplary embodiment, a voice processing device 420 and a microphone 431 are disposed in a set-top box 430.

In this embodiment, when a user inputs voice to the microphone 431 that is mounted on the set-top box 430, the voice processing device 420 recognizes and processes voice. As the microphone 431, like another exemplary embodiment in FIG. 2, a single channel microphone may be used or a multi-channel microphone may be used for removing external noise that is caused by the remote input of voice.

The internal configuration of the voice processing device 420 and contents about a query processing and content search device 450 and a content providing device 460 are similar to those of another exemplary embodiment in FIG. 2, and thus their description will be omitted.

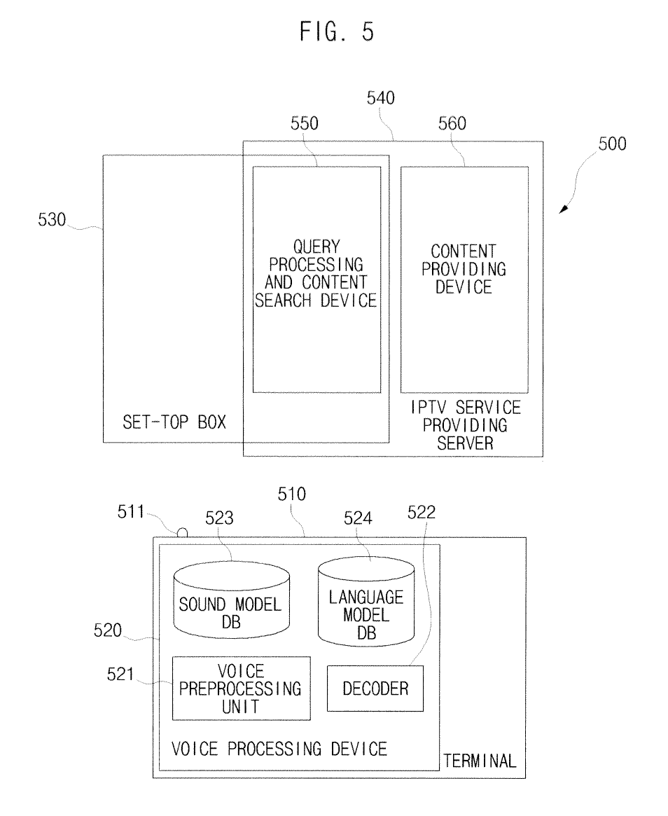

FIG. 5 is a block diagram illustrating the configuration of an IPTV system 500 using voice interface according to another exemplary embodiment. In an IPTV system 500 according to another exemplary embodiment, a microphone 511 for inputting voice and a voice processing device 520 for recognizing voice are integrated with a terminal 510 such as a remote controller.

That is, when a user inputs voice to the microphone 511 of the terminal 510, the voice processing device 520 of the terminal 510 recognizes voice. The voice recognition result of the terminal 510 is transferred to a set-top box 530 through a wireless transmission scheme such as Bluetooth, ZigBee, RF and WiFi or “WiFi+wired network” and is processed. Other system configurations are similar to those of another exemplary embodiment in FIG. 2, and therefore will be omitted.

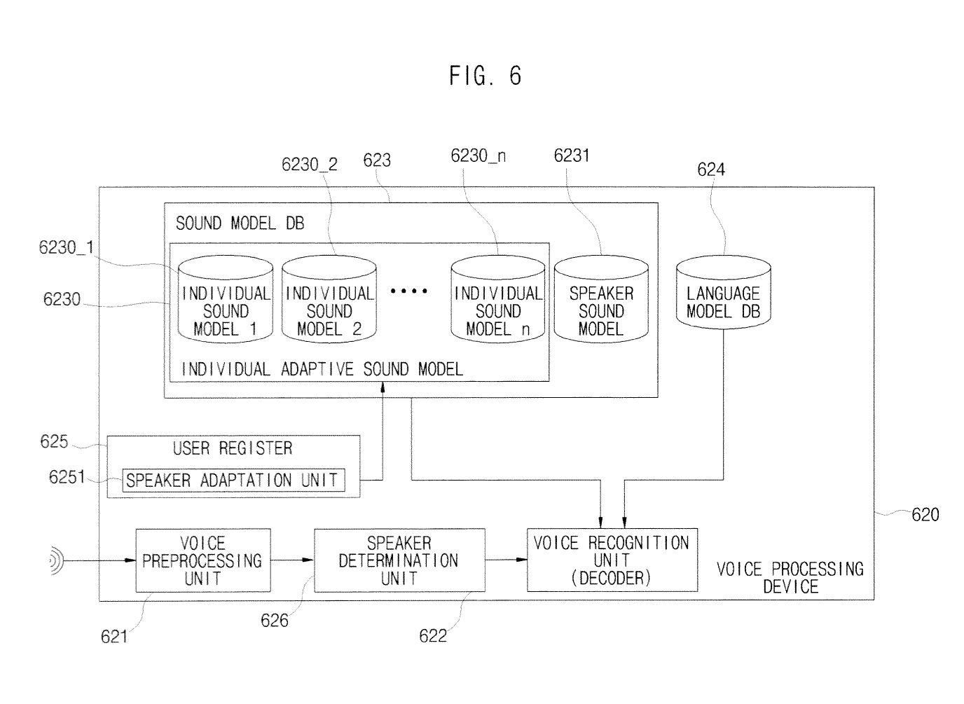

FIG. 6 is a block diagram illustrating a voice processing device which is applied to an IPTV system using voice interface to which personalization service is added, according to another exemplary embodiment.

Referring to FIG. 6, in a voice processing device 620 to which personalization service is added, a sound model database 623 is configured with an individual adaptive sound model database 6230 and a speaker sound model database 6231, instead of a single sound model.

The individual adaptive sound model database 6230 includes a plurality of individual sound model databases 6230_1 to 6230_{—}n. The individual sound model database is configured for each user using a corresponding IPTV system. For example, the individual sound model may be configured for each family member. In this way, by using a sound model which is adapted to individual, voice recognition performance can be improved.

The speaker sound model database 6231 is similar to a sound model database 123 in FIG. 1, and is a sound model database that is used when a user is determined as a speaker other than a family member through speaker determination that will be described below, when the user is determined as any one of family members but reliability is low.

The voice processing device 620 to which personalization service is added includes a user register 625 that registers users using a corresponding IPTV system for speaker adaptation and personalization service. The user register 625 includes a speaker adaptation unit 6251 for creating individual adaptive sound models by user. When a user produces a vocalization list that is provided in the registering of a user, the speaker adaptation unit 6251 creates and adapts the sound model database of a corresponding speaker among the individual adaptive sound model 6230 on the basis of information of the fired list.

Like another exemplary embodiment, a voice preprocessing unit 621 improves the sound quality of an input voice signal, removes the noise of the input voice signal and extracts the feature of the input voice signal. Subsequently, a user is determined through a speaker determination unit 626. An individual adaptive sound model, which is stored in the individual adaptive sound model database 6230 and is adapted when registering a user, may be used to determine users. Afterward, a voice recognition unit (for example, a decoder) 622 receives a feature vector from the voice preprocessing unit 612 as an input, and performs actual voice recognition for converting the feature vector into a text through a sound model database 623 and a language model database 624. At this point, the voice recognition unit 622 recognizes voice by applying the individual adaptive sound model of a corresponding speaker among the individual adaptive sound model 6230 from speaker information inputted from the speaker determination unit 626.

Herein, when reliability for determination does not reach a predetermined reference value although a user is recognized as an external speaker or a speaker included in a family as the result of speaker determination, the voice processing device 620 classifies the user as a general speaker and recognizes voice through the speaker sound model 6231.

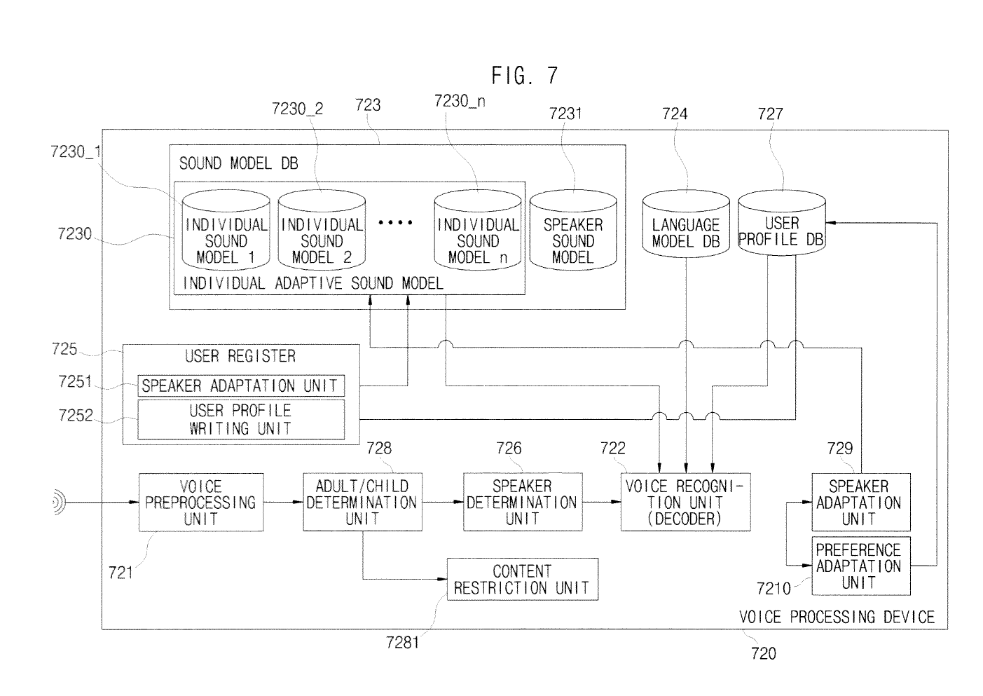

FIG. 7 is a block diagram illustrating a voice processing device which is applied to an IPTV system using voice interface to which personalization service is added, according to another exemplary embodiment.

Referring to FIG. 7, by managing user profiles by individual, a voice processing device 720 may provide various personalization services on the basis of the age and preference of a user, in addition to a voice recognition function by individual. The voice processing device 720 allows the sound model of a corresponding speaker to be adapted to a speaker on the basis of a corresponding voice recognition result and the determination selection of a speaker each time a user selects a result for using an IPTV system, and thus enables a sound model, which is adapted when registering, to far better be adapted to a corresponding speaker.

According to another exemplary embodiment in FIG. 7, for personalization service, the voice processing device 720 includes a speaker adaptation unit 7251 and a user profile writing unit 7252 in a user register 725. The configuration and function of the speaker adaptation unit 7251 are similar to those of another exemplary embodiment in FIG. 6, and repetitive description will be omitted. The user profile writing unit 7252 inputs the individual information of a user using a corresponding IPTV system, for example the ID, sex, age and preference of the user when a family member is registered as the user, thereby enabling the input information to be used for personalization service. The input individual information is stored in a user profile database 727.

Moreover, the voice processing device 720 includes an adult/child determination unit 728 and a content restriction unit 7281, for providing information suitable for a user's age. When voice is inputted to the voice processing device 720, the adult/child determination unit 728 determines an adult and a child on a signal, which is inputted through a voice preprocessing unit 721, by using voice characteristic such as a pitch and a vocalization pattern. When a user is determined as a child as the determination result, the content restriction unit 7281 restricts content that is provided. Herein, the provided content includes a VOD type of content that is provided according to a user's request and a broadcasting channel that is provided real time. That is, when the user is determined as a child as the determination result, the content restriction unit 7281 may restrict broadcasting channels for a corresponding user not to view a specific broadcasting channel.

After an adult and a child are classified through the adult/child determination unit 728, the speaker determination unit 726 determines a speaker, and voice recognition is performed based on the determination result. At this point, a voice recognition operation is as described above with reference to FIG. 6. The result of voice recognition is used for improving the sound model of a corresponding speaker to be further suitable for a speaker on the basis of a voice recognition result and the result selection of a speaker through a speaker adaptation unit 729. A preference adaptation unit 7210 adds and changes the user profile 727 of a corresponding speaker on the basis of a query language that is recognized and extracted from a speaker's voice, a content list that is searched from the query language and the selection result of a user from the content list, thereby enabling personalized information to be provided to a user.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An Internet Protocol Television (IPTV) system using voice interface, comprising:
a voice input device receiving a user's voice;
a voice processing device receiving voice which is inputted to the voice input device, and performing voice recognition to convert the voice into a text;
a query processing and content search device receiving the converted text to extract a query language, and searching content by using the query language as a keyword; and
a content providing device providing the searched content to the user.

2. The IPTV system of claim 1, wherein the voice processing device comprises:
a voice preprocessing unit performing preprocessing which comprises improving the quality of sound or removing noise for the received voice, and extracting a feature vector;
a sound model database storing a sound model which is used to convert the extracted feature vector into a text;
a language model database storing a language model which is used to convert the extracted feature vector into a text; and
a decoder converting the feature vector into a text by using the sound model and the language model.

3. The IPTV system of claim 2, wherein:
the sound model database comprises:
at least ne individual adaptive sound model database storing a sound model which is adapted to a specific user; and
a speaker sound model database used to recognize voice of a user instead of the specific user, and
the voice processing device further comprises:
a user register comprising a first speaker adaptation unit which creates the individual adaptive sound model database corresponding to the user by user; and
a speaker determination unit receiving voice which is inputted to the voice input device, and determining a user which corresponds to the individual adaptive sound model database.

4. The IPTV system of claim 3, wherein the voice processing device further comprises a second speaker adaptation unit improving the individual adaptive sound model database of the user by using the input voice of the user.

5. The IPTV system of claim 3, wherein:
the user register further comprises a user profile writing unit writing a user profile which comprises at least one of an ID, sex, age and preference of the user by user, and
the voice processing device further comprises:
a user profile database storing the user profile; and
a user preference adaptation unit storing at least one of the extracted query language, a list of the searched content and the content provided to a user in the user profile database to improve the user profile.

6. The IPTV system of 2, wherein the voice processing device further comprises:
an adult/child determination unit receiving voice which is inputted to the voice input device, and determining whether a user is an adult or a child using voice characteristic which comprises a pitch or a vocalization pattern; and
a content restriction unit restricting the content which is provided when the user is determined as a child.

7. The IPTV system of claim 1, wherein:
the voice input device is disposed in a user terminal,
the voice processing device is disposed in a set-top box, and
voice which is inputted to the voice input device is transmitted to the voice processing device via a wireless communication.

8. The IPTV system of claim 7, wherein the wireless communication scheme is any one of Bluetooth, ZigBee, Radio Frequency (RF), WiFi and WiFi+wired network.

9. The IPTV system of claim 1, wherein the voice input device and the voice processing device are disposed in a user terminal.

10. The IPTV system of claim 1, wherein the voice input device and the voice processing device are disposed in a set-top box.

11. The IPTV system of claim 10, wherein the voice input device comprises a multi-channel microphone.

12. The IPTV system of claim 2, wherein:
the voice input device and the voice preprocessing unit of the voice processing device are disposed in a user terminal,
a part other than the voice preprocessing unit of the voice processing device is disposed in a set-top box, and
a feature vector which is extracted from the voice preprocessing unit is transferred to a part other than the voice preprocessing unit of the voice processing device in a wireless communication scheme.

13. The IPTV system of claim 12, wherein the wireless communication scheme is any one of Bluetooth, ZigBee, Radio Frequency (RF), WiFi and WiFi+wired network.

14. An Internet Protocol Television (IPTV) service method using voice interface, comprising:
inputting a query voice production of a user;
voice processing the voice production to convert the voice production into a text;
extracting a query language from the converted text to create a content list corresponding to the query language;
providing the content list to the user; and
providing content which is comprised in the content list to the user according to selection of the user.

15. The IPTV service method of claim 14, wherein:
the IPTV service method further comprises creating an individual adaptive sound model database corresponding to the user by user,
the voice processing of the voice production comprises receiving input voice to determine a user corresponding to the individual adaptive sound model database, and
when the individual adaptive sound model database corresponding to the user exists, the voice production is converted into a text by voice processing the voice production with the individual adaptive sound model database corresponding to the determined user.

16. The IPTV service method of claim 15, wherein in the determining of a user, when the individual adaptive sound model database corresponding to the user does not exist, the voice production is converted into a text by voice processing the voice production with a speaker sound model database.

17. The IPTV service method of claim 16, wherein in the determining of a user, when the individual adaptive sound model database corresponding to the user exists but determination reliability for the determined user is lower than a predetermined reference value, the voice production is converted into a text by voice processing the voice production with the speaker sound model database.

18. The IPTV service method of claim 15, further comprising improving the individual adaptive sound model database corresponding to the user by using the voice production of the user which is inputted.

19. The IPTV service method of claim 15, further comprising:
receiving a user profile, which comprises at least one of an ID, sex, age and preference of a user, from the user;
storing the user profile in a user profile database; and
storing at least one of the extracted query language, the searched content list and the content provided to the user in the user profile database to improve the user profile.

20. The IPTV service method of claim 14, further comprising:
receiving voice which is inputted to the voice input device, and determining whether a user is an adult or a child using voice characteristic which comprises a pitch or vocalization pattern of the voice production which is inputted; and
restricting the content which is provided when the user is determined as a child.
